(19) United States
(12) Patent Application Publication
(10) Pub. No.: US 2004/0167845 A1
(43) Pub. Date: Aug. 26, 2004

(54) Method and apparatus for determining a minimum price per click for a term in an auction based internet search

(76) Inventors: Roger Corn, South Pasadena, CA (US); Meghan McArdle, Los Angeles, CA (US); Tom Svrcek, Chevy Chase, MD (US); Jennifer Wu Dorre, Los Angeles, CA (US)

Correspondence Address: BRINKS HOFER GILSON & LIONE, P.O. BOX 10395, CHICAGO, IL, 60610, US

(21) Appl. No.: 10/372,637

(22) Filed: Feb. 21, 2003

(51) Int. Cl. G06F 17/60

(52) U.S. Cl. 705/37

(57) ABSTRACT

A method and apparatus determines a minimum price per click for a term in an auction based internet search by determining a search term which has a low price per click; determining a minimum price per click; setting a minimum price per click value for the search term; and thereby increasing revenue generated by the auction based internet search engine. According to one embodiment of the present invention, a minimum price per click for a term in an auction based internet search is determined by creating search volume tiers. Price per click tiers are then created by partitioning search terms within each search volume tier based upon a price per click for each search term. Finally, a plurality of liquidity tiers are created by partitioning search terms in each price per click tier by liquidity of the search term market place. The results of the partitioning is evaluated to determine a price per click increase to one or more particular terms. Methods for determining a minimum price per click for a term in an auction based internet search includes comparing bids for a particular search term with bids for terms which are similar to the particular search term, its category or class of advertiser.

### FIELD OF THE INVENTION

The present invention relates generally to internet searching, and more particularly to a method of determining a minimum price per click for a term in an auction based internet search.

### BACKGROUND OF THE INVENTION

Since its inception, the Internet has provided a useful tool for searching for information, products or services. The Internet has also provided a means for enabling the purchase of goods and services, and providing advertisements to a vast population of Internet users. As the access to and the use of the internet has continued to increase, new uses for the Internet have continued to evolve. One form of advertising has been to allow vendors to bid for a particular position in a search result, commonly called a paid auction. That is, an advertiser is ranked according to the price per click (“PPC”) for each search term. The price per click is the amount the advertiser will pay if a user “clicks through” on the listing. Vendors can be positioned in a search result depending upon their various bids, and can pay the amount of their respective bids in response to a click through by a user. A click through on a listing redirects a user's web browser to the uniform resource locator (URL) associated with the search listing.

A significant portion of such paid auctions result in bids which are below their true market price, for example, due to a small number of bidders for a particular term. The number of bidders for a particular search term determines the “liquidity” of a search term. Such search terms having a small number of bidding advertisers could be called “illiquid” and therefore, do not capture the true market value bid for the search term. In a paid auction for a particular search term however, the auction will lead to price per clicks for various participants in the auction which reflects the true market value of the search term if a significant number of participants bid in the auction. If only a small number of participants bid in an auction for a particular search term however, the resulting bids may be artificially low because the bidders may not have an incentive to bid higher to end up higher in the search result.

However, participants in an auction related to a term similar to the particular search term, possibly including the participants in an auction for the particular search term itself, may bid significantly higher in an auction related to the similar search term. Such bidding related to the similar search term may reflect that the true market value for the bids related to the particular search term is actually higher than the bids that were presented. That is, the bids for the particular search term may be artificially low because of the small number of bidders in the auction and the lack of meaningful competition among bidders. For example, bids for a misspelled search term may be artificially low because of a small number of bidders. However, a minimum bid could easily be determined based upon bids for the correctly spelled search term.

Accordingly, there is a need for a method to determine a minimum price per click for terms in an internet based auction search.

### BRIEF SUMMARY OF THE INVENTION

A method of an embodiment of the present invention determines a minimum price per click for a term in an auction based internet search by identifying search terms which have a low price per click and setting a minimum price per click value for the search term. Such a minimum price per click increases revenue generated by the auction based internet search, and better enables the commercial search marketplace to simultaneously represent multiple substantive markets for a variety of products and services. Because each search term is considered a market, the method of the present invention increases the economic efficiency of the market by setting subjectively appropriate default bid pricing for the operation of the market.

According to one aspect of the present invention, a minimum price per click for a term in an auction based internet search is determined by creating search volume tiers (SVT). The search volume tiers are created by partitioning search terms based upon the volume of searches on each search term. Price per click tiers are then created by partitioning search terms within each search volume tier based upon a price per click for each search term. Finally, a plurality of liquidity tiers are created by partitioning search terms in each price per click tier by liquidity (e.g. number of bidders for a particular search term). Liquidity can be determined by the number of bidders, the frequency of bid changes, historical trends of the changes, highest maximum bid ever, the offline data regarding the economics of products or services to be offered through this search term. The results of the partitioning is evaluated to determine a price-per-click increase for one or more particular terms. That is, certain tiers may be considered more likely to include terms which are good candidates for a minimum price and will lead to an increase in revenue. For example, higher value illiquid terms will disproportionately increase revenue after a minimum bid and therefore are better identified first. Individual terms within certain tiers can then be further evaluated to determine a minimum price for that term.

According to another aspect of the present invention, a method of determining a minimum price per click for a term in an auction based internet search comprises comparing bids for a particular search term with bids for terms which are similar to the particular search term. That is, the method of one embodiment of the present invention identifies advertisers bidding on a particular search term, and creates a list of other search terms that the advertisers are also bidding on. The method determines a minimum bid for a search term based upon bids related to the other search terms, and applies a minimum bid to the particular search term.

According to another aspect of the present invention, a method of determining a minimum price per click for a term in an auction based internet search enables real time determination of minimum bids. That is, minimum bids can be established for various terms based upon current information of bids for similar or related terms.

### BRIEF DESCRIPTION OF SEVERAL VIEWS OF THE DRAWINGS

FIG. 1 is a block diagram of a network employing the method of determining a minimum price for a search term in an auction based internet search according to the present invention.

FIG. 2 is a block diagram of web pages accessible to advertisers according to the present invention.

FIG. 3 is a web page accessible to an advertiser to enable an advertiser to manage bids according to the present invention.

FIG. 4 is a web page accessible to an advertiser to enable an advertiser to manage bids based upon categories according to the present invention.

FIG. 5 is a web page accessible to an advertiser to enable an advertiser to view the search performance for a particular listing according to the present invention.

FIG. 6 is a web page accessible to an advertiser to enable an advertiser to select bid options according to the present invention.

FIG. 7 is a web page accessible to an advertiser to enable an advertiser to view bid results according to the present invention.

FIG. 8 is a flow chart showing a method of partitioning search terms according to the present invention.

FIG. 9 is a flow chart showing a method of evaluating a particular search term according to the present invention.

FIG. 10 is a flow chart showing a method of determining a minimum price per click for term in an internet based auction search according to the present invention.

FIG. 11 is a chart showing an example of search volume tiers according to the present invention.

FIG. 12 is a chart showing an example of price per click tiers according to the present invention.

FIG. 13 is a chart showing an example of liquidity tiers according to the present invention.

### DETAILED DESCRIPTION OF THE INVENTION

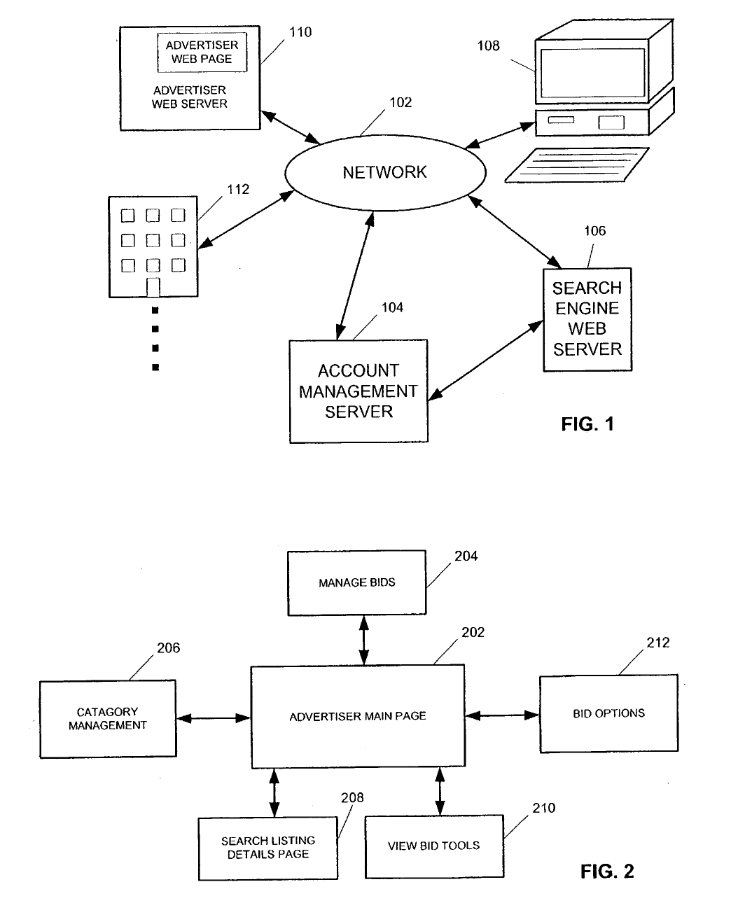

Turning first to FIG. 1, a block diagram of a network employing the method for modifying an internet search result according to the present invention is shown. A network 102, such as a telecommunications network enabling access to the Internet, is coupled to a number of elements which interact to enable the method of the present invention. In particular, an account management server 104 and a search engine web server 106 enable a user to search the Internet by way of the network 102. The operation of the account management server 104 and the search engine web server 106 will be described in more detail reference to remaining figures. Additional information related to the account management server and search engine server, as well as other features of network 102, can be found in U.S. Pat. No. 6,269,361, issued on Jul. 31, 2002 to Davis et al., the entire patent of which is incorporated by reference. A user can search the Internet by way of the search engine web server 106 using a communication device, such as a computer 108. Generally, one conducting an internet search by way of a communication device will be called a user or searcher.

An advertiser's web server 110 enables access to information of the advertiser by way of a communication device employing a search engine, as well as enables an advertiser to access the account management server 104. A vendor site 112, which is also shown, may be accessible by the network 102.

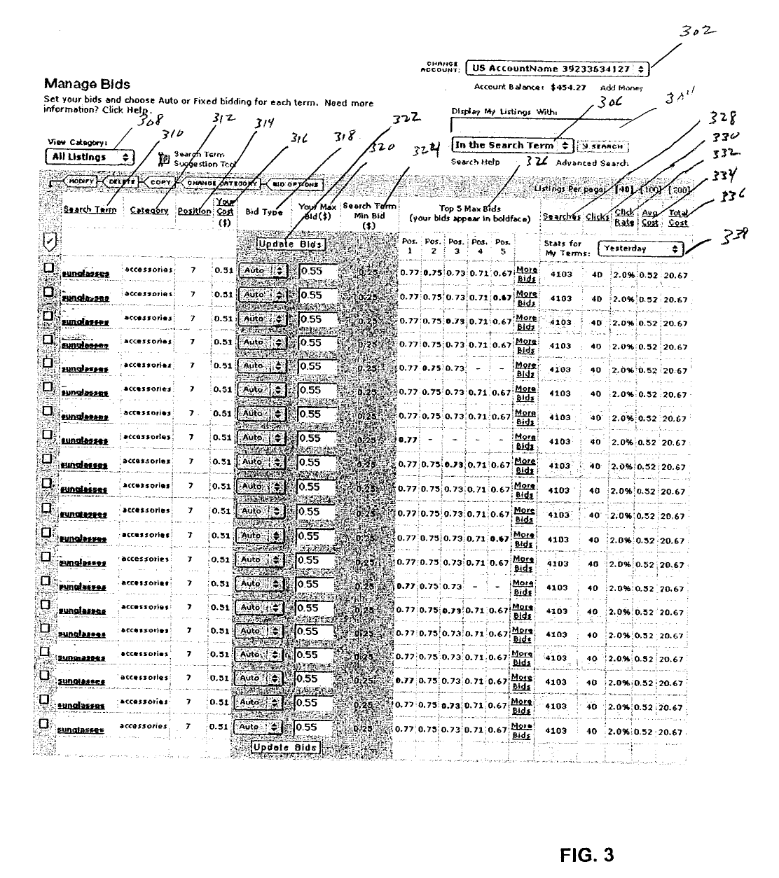

Turning now to FIG. 2, a block diagram shows various web pages accessible to advertisers enabling the method of the present invention. In particular, an advertiser main page 202 enables an advertiser (by way of the account management server 104) to enter information related to the advertiser. For example, after entering proper login information on the advertiser main page 202, an advertiser can manage bids on a manage bids web page 204. Similarly, an advertiser can manage bids according to particular categories on a category management web page 206. An advertiser can also search listing details on a search listing details web page 208. Finally, a user can view bids for a particular search term on a view bids web page 210. While various exemplary web pages are listed in FIG. 2, it will be understood that other web pages available to an advertiser could be employed to enable a vendor to participate in an Internet based search according to be present invention. Specific embodiments of the various web pages listed above will be described in more detail in reference to FIGS. 3-7.

Turning now to FIG. 3, a web page accessible to an advertiser enables an advertiser to manage bids according to the present invention. In particular, an account selection field 302 enables a user to select a particular account. Also, an entry field 304 enables a user to enter a particular term to determine whether the term is found in the selectable field 306. For example, the search for listings would display listings if the term entered in the entry field 304 is found in the field selected in the user selectable field 306. A user can also identify a particular category to be viewed in a selectable field 308.

When results are displayed, the desired search term(s) are displayed in a search term column 310. The category is also provided in a category column 312. The user's position in the search is also listed in a position column 314, as well as the cost for a click through in a column 316. The category management web page also enables updating bids associated with the displayed search terms. In particular, a user can access a user selectable field in a bid type column 318 to select whether automatic or fixed bidding is used for the term. An entry field also enables a user to enter a desired max bid in a max bid column 320. The user can update any changes in the bids using an update bid selection button 322. Finally, a search term minimum bid is listed in a minimum bid column 324. Such a search term minimum bid helps prevent a user from entering a bid which is below a minimum bid.

The category management web page also provides information regarding the maximum bids in a maximum bid field 326, including indicating the user's position in the bids by showing the user's bid in bold. Also, statistics regarding searches for the various terms displayed on the managed bid web page include a search field 328, a click number field 330, a click rate field 332, an average cost field 334, and a total cost field 336. Accordingly, the web page will provide information regarding the fields for a particular date selected in a user selectable date field 338. Although particular fields and features are shown in the category management web page of FIG. 3, fewer or additional fields could be employed according to the present invention.

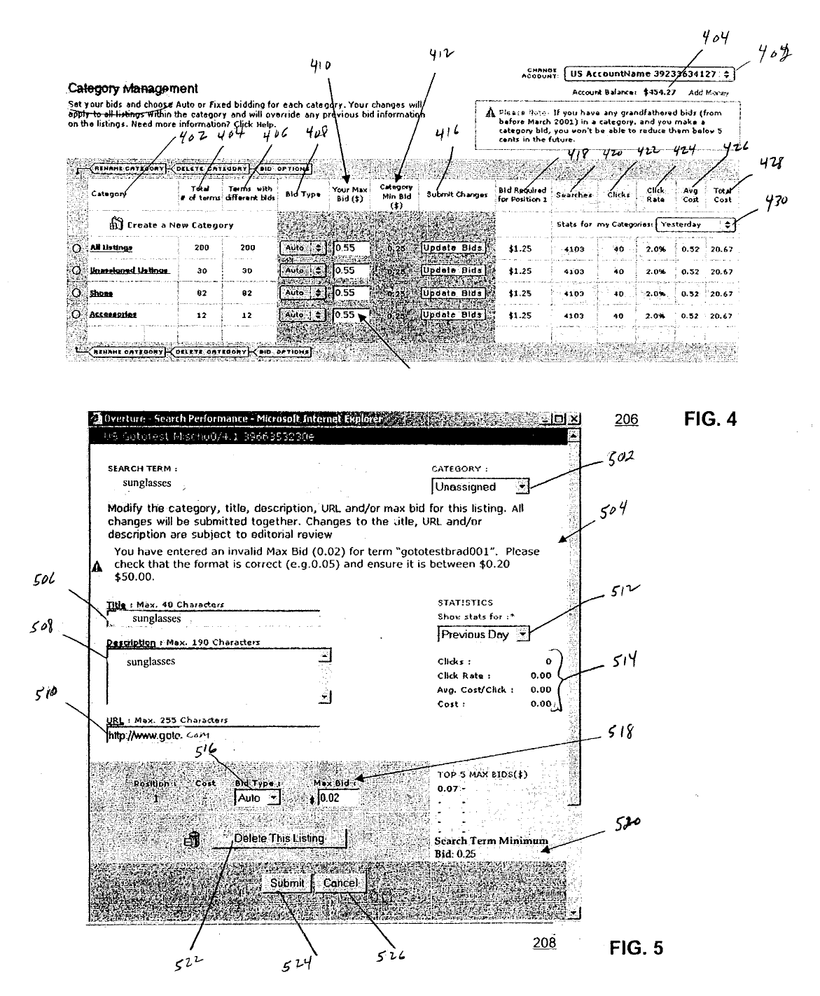

Turning now to FIG. 4, a web page accessible to an advertiser enables an advertiser to manage bids based upon categories according to the present invention. In particular, a category column 402 includes a list of categories which can be selected by a user. A column 404 also indicates the number of terms associated with a particular category, while a column 406 indicates the number of terms with different bids. The category management web page also includes user selectable and entry fields for enabling the user to set bid information related to a particular category. In particular, a user can access a user selectable field in a bid type column 408 to select whether automatic or fixed bidding is used for the term. An entry field also enables a user to enter a desired max bid in a max bid column 410. The user can update any changes in the bids using an update bid selection button 412. Finally, a search term minimum bid is listed in a minimum bid column 414.

The category management web page also provides information regarding the required bid for the first position in a search result in a bid field 418. Also, statistics regarding searches for the various terms displayed on the managed bid web page include a search field 420, a click fielder 422, a click rate field 424, an average cost field 426, and a total cost field 428. Accordingly, the web page will provide information regarding the fields for a particular date selected in a user selectable date field 430. Although particular fields and features are shown in the category management web page of FIG. 3, fewer or additional fields could be employed according to the present invention.

Turning now to FIG. 5, a web page accessible to an advertiser enables an advertiser to view the search performance for a particular listing according to the present invention. In particular, a user selectable category field 502 enables a user to select a particular field to search the performance for a particular listing. A warning message 504 could be displayed on the web page in the event the user entered a max bid which is below the minimum bid for a particular search term. The web page further includes a title entry field 506 enabling a user to enter a particular title, and a description entry field 508 enabling the user to enter a description of the search term. The user may also enter a URL in a URL field 510. The search performance web page also provides statistics for a particular day selected in a user selectable field 512 shown in a statistic field 514. The search performance web page also enables a user to select a bid type in a user selectable bid type field 516, as well as enter a maximum bid in a Max bid entry field 518. Preferably, the search performance web page shows a search term minimum bid 520. Finally, the user can select a plurality of selection buttons, including a delete button 522 to delete the listing, a submit button 524 or cancel button 526.

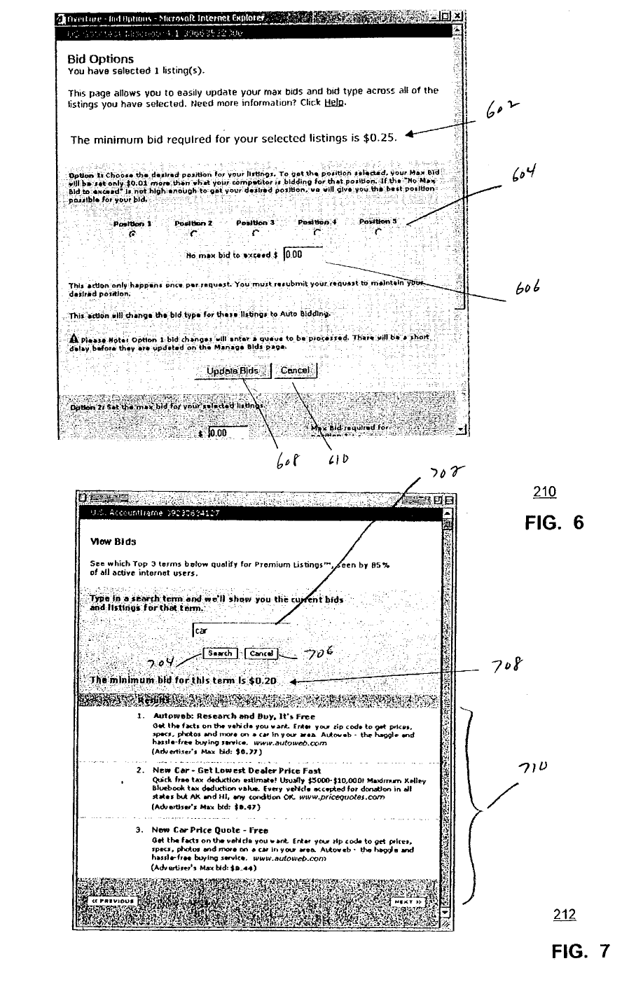

Turning now to FIG. 6, a web page accessible to an advertiser enables the advertiser to select bid options according to the present invention. In particular, a bid options web page enables a user to select options related to a bid on a particular listing. The bid option web page preferably comprises a designation of the minimum bid 602. The bid options web page also enables a user to select a desired position in a search result using a selection field 604. The user may also enter a maximum bid in a user entry field 606. Finally, the user is able to update a bid using an update bid selection button 608 or cancel the bid using a cancel button 610.

Turning now to FIG. 7, a web page accessible to an advertiser enables an advertiser to view bid results according to the present invention. In particular, a user entry field 702 enables a user to enter a term which can then be selected by a search selection button 704, or canceled by a cancel button 706. Preferably, the minimum search term bid is also displayed in a minimum search term field 708. Finally, the search results are displayed in a result field 710.

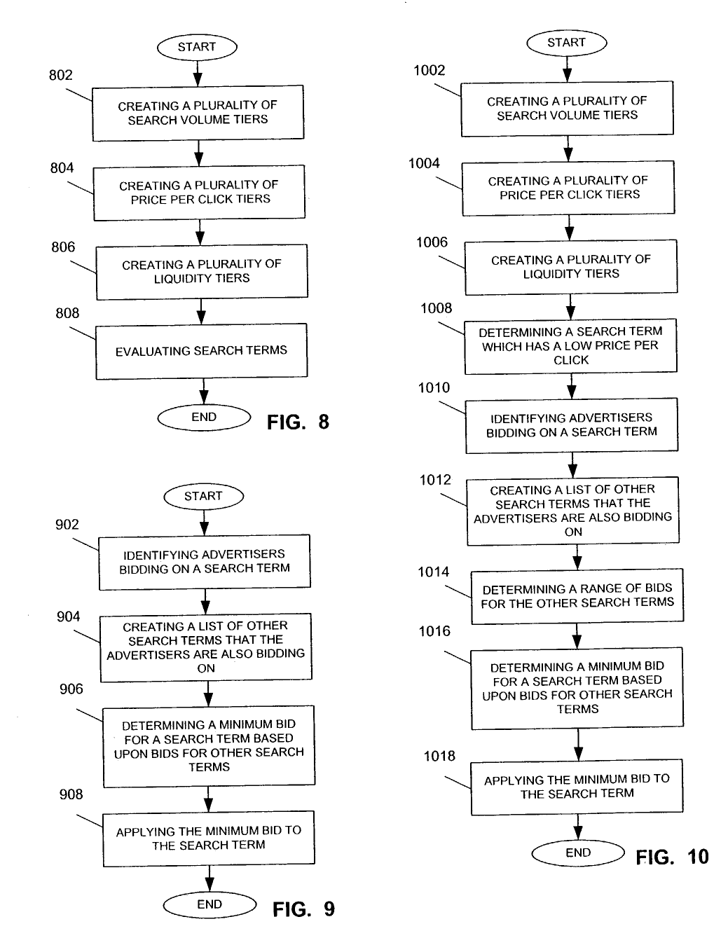

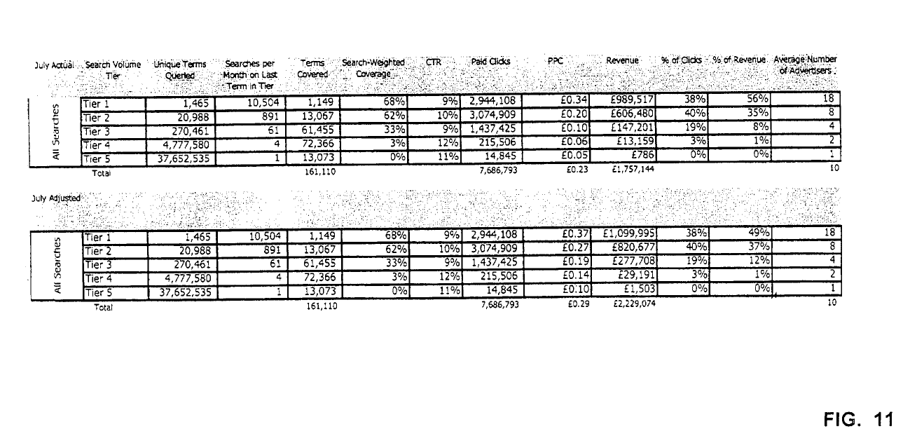

Turning now to FIG. 8, a flow chart shows a method of partitioning search terms according to the present invention. In particular, a plurality of search volume tiers are created a step in 802. The search volume tiers could be based upon, for example, the total number of searches, wherein each tier has an equal number of searches. A plurality of price per click tiers are then created at a step in 804. That is, each search volume tier is divided into a plurality of price per click tiers. The price-per-click for a given term could be, for example, a weighted average price for the search term over some defined period of time. That is, the price-per-click for a given term could be the revenue generated by the term divided by the number of clicks over a predetermined period. A plurality of liquidity tiers are created a step 806. Each price per click tier is further divided based upon liquidity to create liquidity tiers. Liquidity can be determined by the number of bidders, the frequency of bid changes, historical trends of the changes, highest max bid ever, and offline data regarding the economics of products or services to be offered through this search term. Finally, the search terms are evaluated at a step 808. Examples of the various tiers created in the steps of FIG. 8 will be described in more detail in reference to FIGS. 11-13.

In evaluating search terms at a step 808, the search terms are reviewed to determine whether a minimum price per click should be applied to a particular term. There are a number of different ways to apply minimum bids to various terms. One method would be to provide a minimum bid to all search terms. A second method would be to categorize terms which are searched into categories, and apply a minimum bid for all terms in a category. Alternatively, more detailed analysis could be applied to individual terms. Even in cases where a minimum bid is applied to terms in a particular category or an individual term which is analyzed, a default minimum bid could be applied to all remaining terms. In deciding what minimum bid to apply to a particular search term, it may be useful to consider bids of related search terms. One method of applying a more detailed analysis is described in reference to FIG. 9.

Turning now to FIG. 9, a flow chart shows a method of evaluating a particular search term according to the present invention. That is, the method of claim 9 can be employed if a particular search term is selected to be evaluated individually for a minimum bid. In particular, advertisers bidding on the particular search term are identified at a step 902. A list of other such terms that the advertisers are also bidding on is created at a step 904. The list would preferably include those terms which are similar to the particular search term. A minimum bid for the particular search term based upon bids for other search terms is determined at a step 906, and applied for future bidding at a step 908. It should be noted however, that method of the present invention could employ grandfathering, wherein a user could maintain a bid below an established minimum if the user had entered the bid prior to the minimum bid being established. Although the method of FIG. 9 refers to a single search term, the method could also be applied to a number of search terms, such as search terms belonging to a group of similar terms.

Turning now to FIG. 10, a flow chart shows a method of determining a minimum price per click for term in an internet based auction search according to the present invention. In particular, a plurality of search volume tiers are created at a step 1002. A plurality of price for click tiers are created at a step 1004. Further, a plurality of liquidity tiers are created at a step 1006. A search term which has a low price per click is determined at a step 1008. Advertisers bidding on the particular search term are identified at a step 1010. A list of other search terms that the advertisers are also bidding on is created at a step 1012. A range of bids for the other search terms is determined in a step 1014. A minimum bid for a search term based upon the range of bids for the other search terms is then determined at a step 1016. Finally, the minimum bid is then the applied to the search term a step 1018. The methods shown in FIGS. 8-10 could be implemented in software on any computer and enable a service provider to establish and update minimum bids for various terms based upon real time data related to bids.

Turning now to FIG. 11, a chart shows an example of search volume tiers according to the present invention. As shown in FIG. 11, a first chart shows actual data associated with a search volume tiers. The chart shows five tiers, each comprising 20 percent of the total number of searches performed in a given month. However, other criteria, such as creating tiers of predetermined number of search terms, could be employed for creating the search volume tiers according to the present invention. A column also shows the unique term queried within each tier. The tiers are ranked according to the number of searches per term. That is, the first tier comprises terms having the greatest number of searches. Accordingly, the first tier has the fewest number of unique terms which are queried. The chart also shows the searches per month on the last term in the tier. The chart also shows the number of terms which are covered. That is, the chart shows how many terms, of all the terms which are searched, are bid upon by various advertisers. The search weighted coverage, providing a percentage of the total number of searches that include terms that are covered, is also shown.

The chart of FIG. 11 also gives information related to click throughs, and therefore resulting revenue generated by the auctions in a given month. In addition to showing the click through rate (i.e. the percentage of the searches which lead to a click through), a column also shows the number of paid clicks for each tier, as well as the average price per click and the revenue. Finally, columns show the percentage of total clicks corresponding to each tier, as well as the percentage of revenue generated by the each tier and the average number of advertisers per tier. Also shown is a chart having adjusted figures (i.e. having certain terms with minimum bids) for a given month. That is, because the average price per click is higher for at least some of the terms, the overall revenue generated with the same number and distribution of searches is increased.

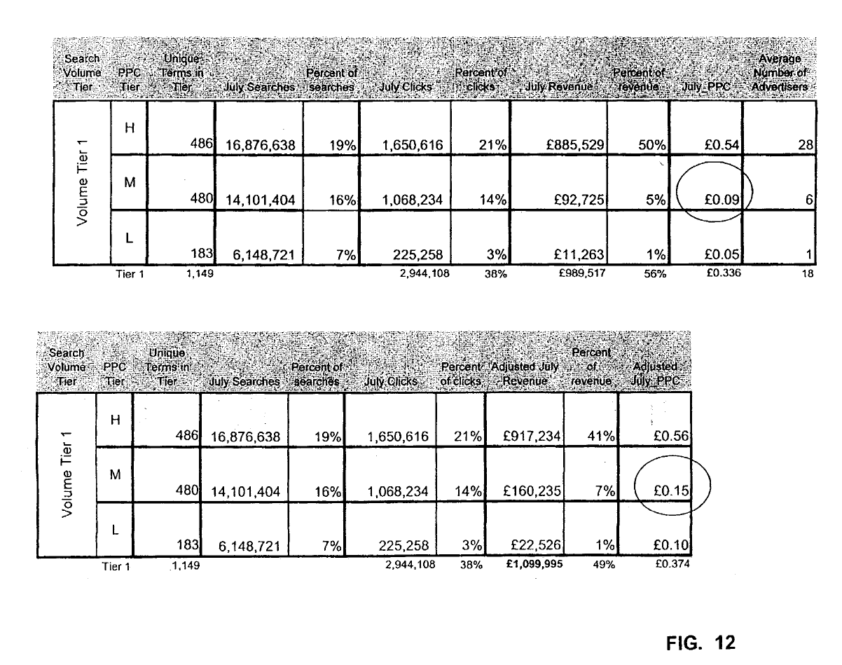

Turning now to FIG. 12, a chart shows an example of price per click tiers according to the present invention. In particular, a given volume tier, shown here as volume tier 1, is divided into a number of price per click tiers. In this example, 3 price per click tiers representing a high, medium and low tiers are created. A column has entries corresponding to each price per click tier indicating unique terms in each tier. Also, a column includes the number of searches for the month associated with each price per click tier, as well as an indication of the percentage of searches corresponding to each price per click tier. Another column also shows the clicks associated with each price per click tier, as well as the percentage of the clicks. Finally, additional columns show the revenue per price per click tier, the percentage of revenue per price per click tier, the average price per click, as well as the average number of advertisers. The price per click tiers could be determined by equal volumes of searches. Alternatively, the price per click tiers could be established based upon ranges of price per click values or some other criteria. Although three price per click tiers are shown for each search volume tier, any number of price per click tiers could be employed. The second chart shows adjusted the price per click data. As can be seen, the revenue increases when the middle tier is given a minimum bid for search terms in that tier.

In determining which terms to evaluate and apply a minimum bid, it may be beneficial to look at terms in particular tiers. For example, terms in volume tier 1 having a medium price per click could have the greatest impact on revenue. The selection of a minimum bid for all terms having a medium price per click could be chosen according to one of the criteria (e.g. global, category or individual) described above. If a global minimum bid is applied generally, the terms would therefore have that minimum bid. Alternatively, a different minimum bid could be applied to terms of a selected group within the medium price per click tier of the volume 1 tier, or more detailed analysis could be applied to an individual term as described for example in FIG. 9. In deciding whether to apply a minimum bid or the value of the minimum bid, the type of product must be considered. Although a minimum bid may generally increase revenue, in some cases a minimum bid may actually decrease revenue. That is, the minimum bid may be a deterent to certain advertisers, causing them to decide not to submit a bid.

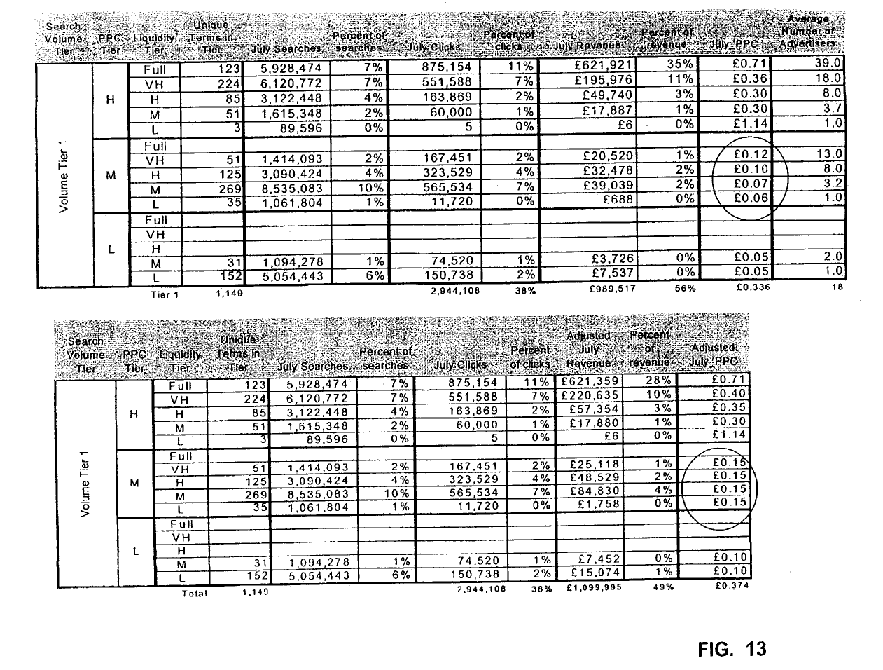

Turning now to FIG. 13, a chart shows an example of liquidity tiers according to the present invention. In particular, each price per click tier within each volume tier is further divided into liquidity tiers. The columns in the chart of FIG. 12 correspond to the columns of the earlier charts. However, by further partitioning the price per click tiers into liquidity tiers, it may be easier to identify terms which are good candidates to apply a minimum bid. That is, because a particular term may have a low number of bidders in any search volume tier or price per click tier, the bids may be artificially low. The liquidity tiers could be chosen to include terms having a certain range of advertisers. For example, each price per click tier could include five categories, such as Full, Very High, High, Medium and Low. The categories could be defined by the number of advertisers for the term. For example, terms having 25-50 advertisers would be full, while terms having 15-25 advertisers would be high, etc. Accordingly, any term in certain liquidity tiers could be considered for a minimum bid. Such minimum bids could be determined based upon a global minimum bid, a category minimum bid, or the term could be analyzed individually for a minimum bid for that term.

It can therefore be appreciated that the new and novel method of determining a minimum price per click for a term has been described. It will be appreciated by those skilled in the art that, particular the teaching herein, numerous alternatives and equivalents will be seen to exist which incorporate the disclosed invention. As a result, the invention is not to be limited by the foregoing embodiments, but only by the following claims.

1. A method of determining a minimum price per click for a term in an auction based internet search, said method comprising the steps of:
determining a search term which has a low price per click;
setting a minimum price per click value for said search term; and
increasing revenue generated by said auction based internet search based upon said minimum price per click.

2. The method of determining a minimum price per click for a term in an auction based internet search of claim 1 further comprising a step of categorizing search terms into a plurality of groups.

3. The method of determining a minimum price per click for a term in an auction based internet search of claim 2 further comprising a step of applying a group minimum price per click value to all search terms in a group of said plurality of groups.

4. The method of determining a minimum price per click for a term in an auction based internet search of claim 1 wherein said step of setting a minimum price per click for said search term comprises setting a minimum price per click for all search terms determined to have a low price per click.

5. The method of determining a minimum price per click for a term in an auction based internet search of claim 1 wherein said step of determining a search term which has a low price per click comprises comparing said search term to similar search terms.

6. The method of determining a minimum price per click for a term in an auction based internet search of claim 5 wherein said step of comparing said search term to similar search terms comprises comparing said search term to similar search terms bid on by a plurality of advertisers bidding on said search term.

7. The method of determining a minimum price per click for a term in an auction based internet search of claim 1 wherein said step of determining a search term which has a low price per click comprises creating volume tiers by partitioning a plurality of search terms by the volume of searches on each search term of said plurality of search terms.

8. The method of determining a minimum price per click for a term in an auction based internet search of claim 7 wherein said step of determining a search term which has a low price per click comprises creating price per click tiers by further partitioning said search terms in each volume tier by an average price per click for each search term.

9. The method of determining a minimum price per click for a term in an auction based internet search of claim 8 wherein said step of determining a search term which has a low price per click comprises further partitioning said search terms in each price per click tiers by the liquidity for a market.

10. The method of determining a minimum price per click for a term in an auction based internet search of claim 9 wherein said step of setting a minimum price per click for said search term comprises setting a minimum price per click to a category of search terms.

11. The method of claim 1 wherein said step of determining a search term which has a low price per click comprising evaluating real time bidding data.

12. The method of claim 11 wherein said step of setting a minimum price per click for said search term comprises setting a minimum price for a search term based upon real time bidding data.

13. A method of determining a minimum price per click for a term in an auction based internet search, said method comprising the steps of:
creating a plurality of search volume tiers by partitioning a plurality of search terms into a plurality of search volume tiers based upon the volume of searches on each search term of said plurality of search terms;
creating a plurality of price per click tiers by partitioning search terms within each search volume tier based upon a price per click for each search term;
creating a plurality of liquidity tiers by partitioning search terms in each price per click tier by liquidity; and
evaluating a search term to determine a new price per click value increase.

14. The method of determining a minimum price per click for a term in an auction based internet search of claim 13 further comprising a step of setting a minimum price per click value for a search term.

15. The method of determining a minimum price per click for a term in an auction based internet search of claim 13 wherein said step of evaluating a search term comprises organizing said search terms into a plurality of categories of search terms.

16. The method of determining a minimum price per click for a term in an auction based internet search of claim 15 wherein said step of evaluating a search term comprises comparing a search term to similar search terms in a category of search terms.

17. The method of determining a minimum price per click for a term in an auction based internet search of claim 16 wherein said step of comparing a search term to similar search terms comprises comparing said search term to similar search terms bid on by advertisers bidding on said search term.

18. The method of determining a minimum price per click for a term in an auction based internet search of claim 17 wherein said step of comparing said search terms to similar search terms bid on by advertisers bidding on said search term comprises creating a list of similar search terms that are bid on by said advertisers.

19. The method of determining a minimum price per click for a term in an auction based internet search of claim 18 further comprising a step of identifying a range of bids on said similar search terms.

20. The method of determining a minimum price per click for a term in an auction based internet search of claim 19 further comprising a step of applying a group minimum price per click to all search terms in a category of search terms.

21. The method of determining a minimum price per click for a term in an auction based internet search of claim 13 further comprising a step of selecting search terms of said plurality of search terms to apply a minimum price per click.

22. The method of claim 13 wherein said step of creating a plurality of search volume tiers comprising evaluating real time bidding data.

23. The method of claim 22 wherein said step of evaluating a search term comprises setting a minimum price for a search term based upon real time bidding data.

24. A method of determining a minimum price per click for a term in an auction based internet search, said method comprising the steps of:
creating a plurality of search volume tiers by partitioning a plurality of search terms into a plurality of search volume tiers based upon the volume of searches on each search term of said plurality of search terms;
creating a plurality of price per click tiers by partitioning search terms within each search volume tier based upon a price per click for each search term;
creating a plurality of liquidity tiers by partitioning search terms in each price per click tier by liquidity;
determining which search terms of said plurality of search terms should be evaluated for a minimum price per click value;
evaluating said search terms for a minimum price per click value; and
establishing a minimum price per click value for at least one search term.

25. A method of determining a minimum price per click for a term in an auction based internet search, said method comprising the steps of:
identifying advertisers bidding on a search term;
creating a list of other search terms that said advertisers are also bidding on;
determining a minimum bid for a search term based upon bids related to the other search terms; and
applying a minimum bid to said search term.

26. The method of determining a minimum price per click for a term in an auction based internet search of claim 25 further comprising a step of categorizing search terms into a plurality of groups.

27. The method of determining a minimum price per click for a term in an auction based internet search of claim 26 further comprising a step of applying a group minimum price per click value to all search terms in a group of said plurality of groups.

28. The method of determining a minimum price per click for a term in an auction based internet search of claim 25 wherein said step of determining a minimum bid for a search term comprises identifying a range of bids for the other search term.

29. The method of determining a minimum price per click for a term in an auction based internet search of claim 25 further comprising a step of determining a search term which has a low price per click by partitioning a plurality of search terms by the volume of searches on each search term of said plurality of search terms to create a plurality of volume tiers.

30. The method of determining a minimum price per click for a term in an auction based internet search of claim 29 wherein said step of determining a search term which has a low price per click comprises creating price per click tiers by further partitioning said search terms in each volume tier by a price per click for each search term.

31. The method of determining a minimum price per click for a term in an auction based internet search of claim 30 wherein said step of determining a search term which has a low price per click comprises further partitioning each search term in each price per click tiers by the liquidity for each said search term.

32. The method of determining a minimum price per click for a term in an auction based internet search of claim 31 wherein said step of setting a minimum price per click for said search term comprises setting a minimum price per click to a category of search terms.

33. A method of determining a minimum price per click for a term in an auction based internet search, said method comprising the steps of:
creating a plurality of search volume tiers by partitioning a plurality of search terms into a plurality of search volume tiers based upon the volume of searches on each search term of said plurality of search terms;
creating a plurality of price per click tiers by partitioning search terms within each search volume tier based upon a price per click for each search term;
creating a plurality of liquidity tiers by partitioning search terms in each price per click tier by liquidity;
evaluating said search terms in predetermined tiers based upon real time data;
determining a search term which has a low price per click;
identifying advertisers bidding on a search term;
creating a list of other search terms that said advertisers are also bidding on;
determining a minimum bid based upon the bids related to the other search terms; and
setting a minimum price per click value for said search term based upon real time data.

34. A system for determining a minimum price per click for a term in an auction based internet search, said system comprising:
a server receiving a bid for a search term in an auction based internet search, said server determining that said search term has a low price per click;
a database coupled to said server and storing information related to a plurality of search terms; and
a minimum price per click established by said server based upon information related to said plurality of search terms and stored in said database.

35. The system for determining a minimum price per click for a term in an auction based internet search of claim 34 further comprising a minimum price per click for all search terms determined to have a low price per click.

36. The system for determining a minimum price per click for a term in an auction based internet search of claim 34 wherein said database comprises search terms categorized in a plurality of groups.

37. The system for determining a minimum price per click for a term in an auction based internet search of claim 36 further comprising a group minimum price per click value for all search terms in a group of said plurality of groups.

38. The system for determining a minimum price per click for a term in an auction based internet search of claim 36 wherein said group of search terms comprises terms similar to said search term.

39. The system for determining a minimum price per click for a term in an auction based internet search of claim 38 wherein said group of search terms comprises similar terms bid on by a plurality of advertisers bidding on said search term.

40. The system for determining a minimum price per click for a term in an auction based internet search of claim 38 further comprising a plurality of volume tiers associated with said group of search terms.

41. The system for determining a minimum price per click for a term in an auction based internet search of claim 40 further comprising a plurality of price per click tiers associated with each volume tier of said plurality of volume tiers.

42. The system for determining a minimum price per click for a term in an auction based internet search of claim 41 further comprising liquidity tiers associated with each price per click tier of said plurality of price per click tiers.

43. The system for determining a minimum price per click for a term in an auction based internet search of claim 42 further comprising a minimum price per click for all search terms in a liquidity tier.
